(19) United States
(12) Patent Application Publication
(10) Pub. No.: US 2009/0002788 A1
(43) Pub. Date: Jan. 1, 2009

(54) VERIFICATION OF DATA STORAGE HOLOGRAMS

(76) Inventors: Allen Keith Bates, Tucson, AZ (US); Nils Haustein, Soergenloch (DE); Craig Anthony Klein, Tucson, AZ (US); Daniel James Winarski, Tucson, AZ (US)

Correspondence Address: JOHN H. HOLCOMBE;IBM CORPORATION, IP LAW DEPT., 8987 E. TANQUE VERDE RD., #309-374, TUCSON, AZ, 85749, US

(21) Appl. No.: 11/771,104

(22) Filed: Jun. 29, 2007

(51) Int. Cl. G02B 5/32

(52) U.S. Cl. 359/22; 359/15

(57) ABSTRACT

A holographic storage drive of a holographic data storage system is configured to write and read holograms with respect to a plurality of locations of a holographic storage medium; and a control is configured to operate the holographic storage drive to write a known image aggregated with data in the form of a hologram to the holographic storage medium; to operate the holographic storage drive to read back the written hologram, employing a partial matched filter to cross-correlate the read-back image with the ideal version of the known image, excluding the remainder of the written hologram; and to determine whether the cross-correlation at least meets a write/readback threshold.

### DOCUMENT INCORPORATED BY REFERENCE

Commonly assigned U.S. patent application Ser. No. 11/737,670 is incorporated for its showing of holographic data storage systems and matched filters.

### FIELD OF THE INVENTION

This invention relates to holographic data storage, and, more particularly, to the storage of data as holograms at a plurality of locations of a holographic storage medium

### BACKGROUND OF THE INVENTION

Holographic storage comprises a high density data storage capability. Typically, data is recorded into a holographic medium by employing a data beam that is two-dimensional in nature and comprises a rectangular image of a large number of bits arranged in a raster pattern. The data beam and a reference beam are separately directed to the holographic medium and intersect and interfere to form an interference wave front that is recorded as a holographic image known as a hologram into the holographic medium. Additional holograms may be recorded along linear tracks and at various depths of the holographic medium to provide a high capacity data storage.

### SUMMARY OF THE INVENTION

Holographic data storage systems, computer program products and methods are configured to determine the verification of data storage holograms.

In one embodiment, a holographic storage drive of a holographic storage system is configured to write and read holograms with respect to at least one holographic storage medium, the holograms at a plurality of locations of a holographic storage medium; and a control of the holographic data storage system is configured to operate the holographic storage drive to write a known image aggregated with data in the form of a hologram to the holographic storage medium; to operate the holographic storage drive to read back the written hologram, employing a partial matched filter to cross-correlate the read-back image with the ideal version of the known image, excluding the remainder of the written hologram; and to determine whether the cross-correlation at least meets a write/readback threshold.

In a further embodiment, the control is configured to, if the control determines the cross-correlation fails to meet the write/readback threshold, operate the holographic storage drive to write the aggregated known image and the data in the form of a hologram at another location of the at least one holographic storage medium.

In another embodiment, the control is additionally configured to operate the holographic storage drive to read a hologram having the aggregated known image and data from the holographic storage medium, employing a partial matched filter to cross-correlate the read image with the ideal version of the known image, excluding the remainder of the read hologram; and to determine whether the cross-correlation at least meets a read threshold.

In a further embodiment, the read threshold is less stringent than the write/readback threshold.

In a still further embodiment, the control is configured to, if the control determines the cross-correlation fails to meet the read threshold, operate the holographic storage drive to write the aggregated known image and the read data in the form of a hologram at another location of the at least one holographic storage medium.

In another embodiment, the holographic storage drive is configured to read back the written hologram by illuminating the written hologram with an object wave; and the control is configured to operate the holographic storage drive to provide the ideal version of the known image as the object wave and to cross-correlate the resultant wave image employing a partial matched filter matched to the impulse response of a reference wave for the known image.

In still another embodiment, the holographic storage drive is configured to read back the written hologram by illuminating the written hologram with a reference wave; and the control is configured to cross-correlate the resultant wave image employing a partial matched filter matched to the impulse response of an ideal version of the known image.

In another embodiment, the holographic storage drive is configured to read back the read hologram by illuminating the hologram with an object wave; and the control is configured to operate the holographic storage drive to provide the ideal version of the known image as the object wave and to cross-correlate the resultant wave image employing a partial matched filter matched to the impulse response of a reference wave for the known image.

In still another embodiment, wherein the holographic storage drive is configured to read back the read hologram by illuminating the hologram with a reference wave; and the control is configured to cross-correlate the resultant wave image employing a partial matched filter matched to the impulse response of an ideal version of the known image.

For a fuller understanding of the present invention, reference should be made to the following detailed description taken in conjunction with the accompanying drawings.

### BRIEF DESCRIPTION OF THE DRAWINGS

FIG. 1 is a diagrammatic illustration of an embodiment of a holographic storage drive in accordance with the present invention;

FIG. 2 is a schematic illustration of the holographic storage drive of FIG. 1;

FIG. 3 is diagrammatic illustration of holographic media employed in the holographic storage drive of FIGS. 1 and 2;

FIG. 4 is a schematic illustration of the holographic storage drive of FIGS. 1 and 2 employed in a read process;

FIG. 5 is a schematic illustration of the holographic storage drive of FIGS. 1 and 2 employed in an alternative read process;

FIG. 6 is a schematic illustration of an alternative embodiment of a holographic storage drive in accordance with the present invention; and

FIG. 7 is a flow chart depicting an embodiment of the present invention.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

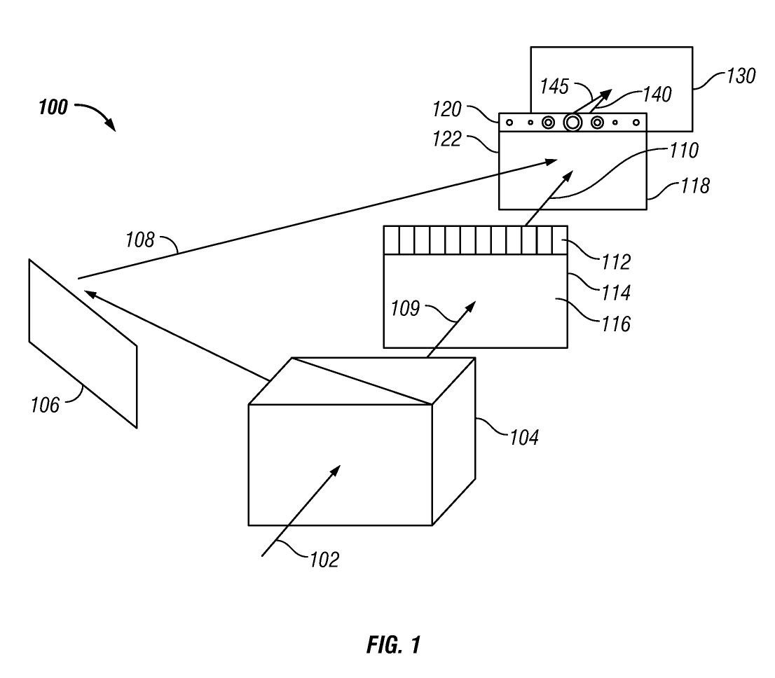

Referring to FIGS. 1, 2 and 3, an embodiment of a holographic storage drive 100 of a holographic storage system 200 is illustrated having one possible type of write path, called a “transmissive” light path. A light source 101 provides a laser beam 102 which is split by beam splitter 104 into a reference beam 108 and a carrier beam 109. The reference beam 108 is reflected by surface mirror 106 to the holographic storage media 119. The carrier beam 109 passes through a transmissive spatial light modulator (TSLM) 114 and is modulated thereby to provide a signal beam 110. As examples, the laser beam 102 may be at a blue wavelength of 405 nm, or may be at a green light wavelength of 532 nm, or may be at a red light wavelength of 650 nm, or at an infrared wavelength of 780 nm, or another wavelength of light tuned to the recording and/or reading characteristics of the holographic storage media. The holographic storage media 119 may comprise an element of the holographic storage drive 100, or alternatively be removable.

In holographic information storage, an entire segment of information 118 is stored at once as an optical interference pattern within a thick, photosensitive optical material, such as holographic storage media 119. This is done by intersecting two coherent laser beams within the material. One beam, called the reference beam 108, is designed to be simple to reproduce, for example, a collimated beam with a planar wavefront. The other beam, called the signal beam 110, is modulated so as to contain the information to be stored. The resulting optical interference pattern from the two coherent laser beams causes chemical and/or physical changes in the photosensitive optical material to provide a replica of the interference pattern. As examples, the replica of the interference pattern is stored as a change in the absorption, refractive index, or thickness of the photosensitive optical material. When the stored interference pattern, called a hologram, is illuminated with one of the two waves that were used during recording, some of the incident light is diffracted by the stored interference pattern in such a fashion that the information can be read by a detector 130. Illuminating the hologram 118 with the reference beam 108 reconstructs the stored information as beam 145, and illuminating the hologram 118 with the signal beam 110 reconstructs the reference beam as beam 140.

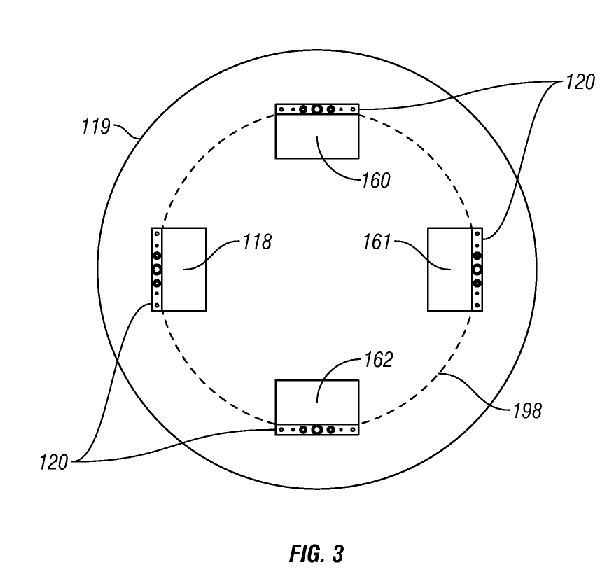

A large number of these holograms may be superimposed in the same media and can be accessed independently, as long as they are distinguishable by the direction or the spacing of the holograms. Such separation can be accomplished by changing the angle between the signal and reference beams or by changing the laser wavelength. Also, the holographic storage drive may reposition the holographic storage media 119. Any particular hologram can then be read out independently by illuminating the hologram with a beam that was used to store that hologram. Because of the thickness of the hologram, the beam is diffracted by the interference pattern in such a fashion that only the desired beam is significantly reconstructed and imaged on a detector 130. Examples of various holograms are illustrated in FIG. 3 as holograms 118, 160, 161 and 162, in the example distributed on data track 198. Alternatively or additionally, holograms may be distributed laterally or within the thickness of the holographic storage media.

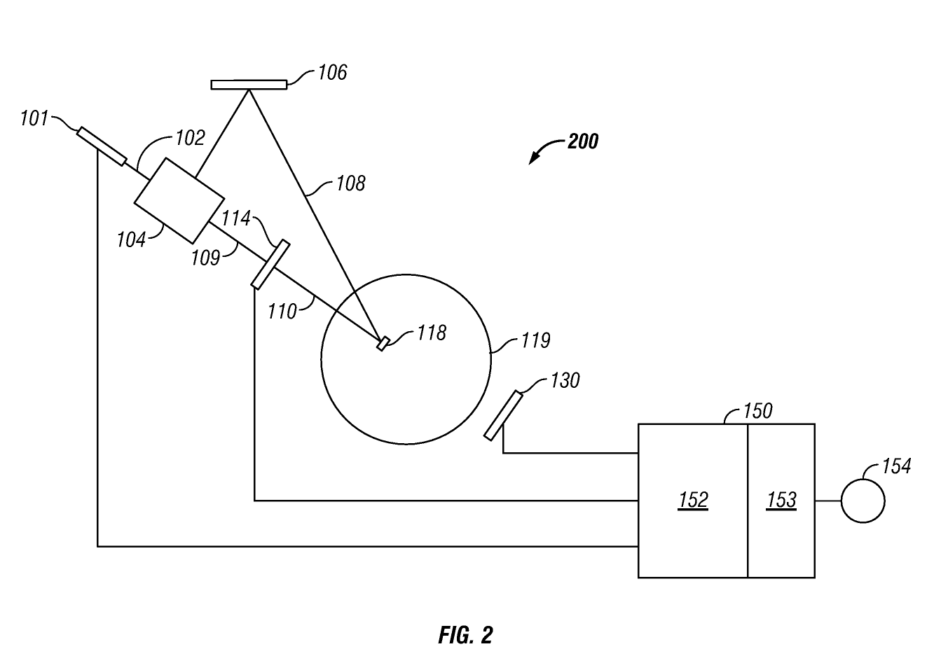

Referring to FIGS. 1 and 2, a transmissive spatial light modulator (TSLM) 114 may comprise a translucent LCD-type device, where information is represented by either a light or a dark pixel on the TSLM display. The carrier beam 109 picks up the image 112, 116 displayed by the TSLM 114 as the light passes through the TSLM and is modulated thereby to provide the signal beam 110 which is directed to the holographic storage media 119 to then interfere with reference beam 108 to form hologram 118 comprising portions 120, 122.

Referring to FIGS. 1 and 2, the holographic storage drive 100 is operated by a control 150, comprising one or more computer processors 152 and one or more memories or storage apparatus 153. The control 150 and the holographic storage drive may form a holographic storage system 200, or the control may comprise or be supplemented by additional computer processors which together operate the drive to provide the storage functionality of the holographic storage system. For example, the control 150 operates the light source 101, the TSLM 114, the detector 130, and the positioning of the beams and/or the holographic storage media 119.

The invention can take the form of an entirely hardware embodiment, an entirely software embodiment or an embodiment containing both hardware and software elements, which includes but is not limited to resident software, microcode, firmware, etc.

Furthermore, the invention can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer readable medium include a semiconductor or solid state memory, magnetic tape, a removable computer diskette, and random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor 152 coupled directly or indirectly to memory elements 153 through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices 154 (including but not limited to keyboards, displays, pointing devices, etc.) can be coupled to the system either directly or through intervening I/O controllers. Connections to the I/O may encompass connection links including intervening private or public networks. The communication links may comprise serial interconnections, such as RS-232 or RS-422, Ethernet connections, SCSI interconnections, iSCSI interconnections, ESCON interconnections, Fibre Channel interconnections, FICON interconnections, a Local Area Network (LAN), a private Wide Area Network (WAN), a public wide area network, Storage Area Network (SAN), Transmission Control Protocol/Internet Protocol (TCP/IP), the Internet, and combinations thereof.

Referring to FIGS. 1, 2 and 3, in one embodiment, the holographic storage drive 100 of a holographic data storage system 200 is configured to write and read holograms 118, 160, 161, 162 at a plurality of locations of at least one holographic storage medium 119. The control of the holographic data storage system is configured to operate the holographic storage drive to write a known image 120 aggregated with data 122 in the form of a hologram 118 to the holographic storage medium 119. One portion of the carrier beam 109 becomes encoded with the known image 120 from a known image generator 112 and another portion of the carrier beam is encoded with data from the data portion 116 of the transmissive spatial light modulator (TSLM) 114. The known image 120 may comprise an image generated by the control 150 or may comprise an optical image. The TSLM and/or known image generator form the signal beam 110, which contains the information to be stored. The resulting optical interference pattern from the signal beam 110 and reference beam 108 cause changes in the photosensitive optical material to provide a replica hologram 118 of the interference pattern.

The control 150 operates the holographic storage drive 100 to read back the written hologram 118, employing a partial matched filter to cross-correlate the read-back image of the known image 120 with the ideal version of the known image 112, excluding the remainder 122 of the written hologram; and to determine whether the cross-correlation at least meets a write/readback threshold.

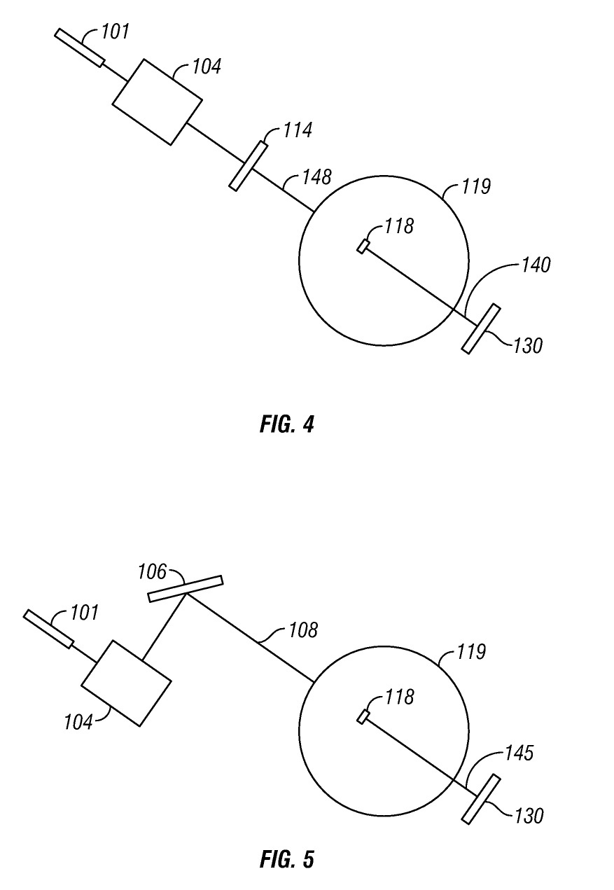

Referring to FIGS. 4 and 5, there are two ways to read a hologram generated by the interference of a reference beam and a signal beam. In the example of FIG. 4, the hologram 118 is illuminated with the original signal beam as the object wave 148. For example, light source 101 provides a laser beam 102 which beam splitter 104 supplies as a carrier beam 109. The beam splitter may block a reference beam or the mirror may direct the reference beam away from the hologram. The carrier beam 109 passes through the transmissive spatial light modulator (TSLM) 114 and is modulated thereby to provide an object wave 148 that comprises the desired known image. The object wave 148 may comprise only the known image from known image generator 112 or may include a data portion 122 from a data portion of the TSLM.

The desired known image of the object wave 148 illuminates the hologram 118 and the incident light is diffracted by the stored interference pattern in such a fashion that an output beam 140 is produced that comprises information can be read by detector 130. The information read by the detector should resemble the original reference beam used to write the hologram. In an abstract sense, a hologram that is being read can be thought of as a little like an optical XOR operation, where the stored HOLOGRAM=REFERENCE WAVE <XOR> SIGNAL BEARING WAVE, and the read output beam 140 is SIGNAL BEARING WAVE <XOR> HOLOGRAM=REFERENCE WAVE.

Alternatively, in the example of FIG. 5, the hologram 118 is illuminated with the reference beam as the object wave 108 and the desired information of the original signal beam is reconstructed as beam 145 and is projected onto the detector 130. For example, light source 101 provides a laser beam 102 which beam splitter 104 supplies as a reference beam to form object wave 108. The beam splitter may block a carrier beam or the transmissive spatial light modulator (TSLM) may blank out any image via all dark pixels. The reference beam is reflected by mirror 106 to illuminate the hologram 118 and the incident light is diffracted by the stored interference pattern in such a fashion that an output beam 145 is produced that comprises information can be read by detector 130. The information read by the detector should resemble the original known image of the signal beam used to write the hologram. As above, a hologram that is being read can be thought of as a little like an optical XOR operation, where the stored HOLOGRAM=REFERENCE WAVE <XOR> SIGNAL BEARING WAVE, and the read output beam 145 is REFERENCE WAVE <XOR> HOLOGRAM SIGNAL BEARING WAVE.

Referring to FIGS. 1, 2, 4 and 5, control 150 employs a partial matched filter to cross-correlate the read-back image of the known image 120 with the ideal version of the known image 112, excluding the remainder 122 of the written hologram; and to determine whether the cross-correlation at least meets a write/readback threshold. The partial matched filter cross-correlation calculation is a two argument calculation where one argument is the impulse response of the ideal image stored in memory 153 and the second argument is the “copy” of that image read at detector 130 from the media 119. In the case of the use of the known image as the illumination of FIG. 4, the ideal image is the reference wave, and in the case of the use of the reference beam as the illumination of FIG. 5, the ideal image is the known image.

The control 150 performs the following calculation between the respective image g(x,y) read from the hologram and the matched filter matched to the impulse response h(x,y)=s*(−x,−y) of the ideal case of that same image, as shown in eqn. (1). For example, for use of the known image for illumination of FIG. 4, V(x,y) in eqn. (1) is the cross-correlation between the reference beam read from the disk g(x,y) and the actual reference beam s(x,y). Alternatively, for use of the reference beam 108 for illumination of FIG. 4, V(x,y) in eqn. (1) is the cross-correlation between the image read from 120 of hologram 118 read from the media g(x,y) and the actual reference image 112 s(x,y). The correlation of the arguments is to identify the extent of imperfections. V(x,y) has to meet or exceed a threshold of imperfections for the correlation to be acceptable.

Eqn[1] comprises a double integral, meaning that the integration is over the X axis and Y axis directions of the detector 130. The calculation is a partial matched filter in that the integration is only over the area of the known image, thereby excluding and effectively masking the remainder of the hologram. ξ is the integration variable along the X axis of detector 130, η is the integration variable along the Y axis of detector 130, and * denotes a complex conjugate.

V(x,y)=∫∫g(ξ,η)s*(ξ−x,η−y)]dξdη Eqn. [1]

Mathematically, V(x,y) is a surface varying along the X axis and the Y axis, for each (x,y). There is one value of V(x,y) for each detector element in detector 130. The range of V(x,y) for each (x,y) is between −1 and +1, where +1 represents the ideal correlation of one hundred percent (100%). To maximize V(x,y), the following difference surface, Difference(x,y), is defined in Eqn[2]. As shown, Difference(x,y) is calculated by subtracting the matched filter correlation V(x,y) from unity. Difference(x,y) may be evaluated (a) point-to-point, (b) as an arithmetic mean, (c) as a geometric mean, and (d) as a root-mean-square. Difference(x,y) ranges between 0 and +2, and the ideal difference for each value of (x,y) is 0, meaning for a value of 0 that there is no difference between the image 140 or 145 read from the holographic media 119 and the ideal holographic pattern at that point (x,y). Difference(x,y) may be evaluated point-by-point in read difference calculations, but the control 150 alternatively may quantify surface Difference(x,y) in terms of a single number, to simplify read difference calculations. Such single numbers may be MAX_Difference which is equal to the maximum value of Difference(x,y). Alternately AM_Difference, the arithmetic mean of the values of Difference(x,y), GM_Difference, the geometric mean of the values of Difference(x,y), or RMS_Difference, the root-mean-square of the values of Difference(x,y) may be used in the read difference calculations.

Difference(x,y)=1−V(x,y) Eqn. [2]

V(x,y) would have to exceed a threshold for the correlation to be acceptable. Alternately, Difference(x,y), MAX_Difference, AM_Difference, GM_Difference, or RMS_Difference, would have to be beneath a threshold for the correlation to be acceptable. It is the set of Difference(x,y), MAX_Difference, AM_Difference, GM_Difference, and RMS_Difference which give the most flexibility for implementation.

The correlation can never exceed a 100% correlation (a perfect condition). However, a correlation less than 100% means that imperfections exist.

In the example of FIG. 4, where the read output beam 140 comprises the wave resembling the reference wave that was used to write the hologram, if the correlation is 100%, all points of the detector 130 would be “1”s, and the correlation calculation would produce all “1”s (100%).

Thus, the terms “cross-correlation”, “partial matched filter” and “known image” refer to whatever means is used to make the correlation, whether the known image is used to generate a read output beam that resembles the reference wave and the correlation calculation is with respect to the impulse response of the reference wave, or whether a reference wave is used to generate a read output beam that resembles the known image and the correlation calculation is with respect to the impulse response of the known image.

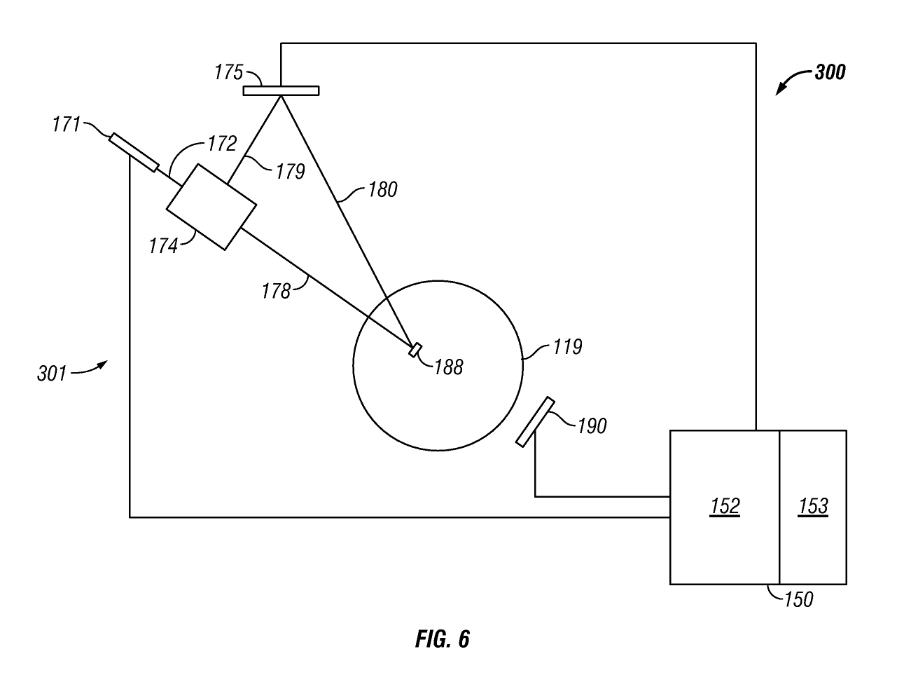

FIG. 6 represents an alternative embodiment of a holographic storage system 300 having a holographic storage drive 301 with an alternative type of write path, called a “reflective” light path. A light source 171 provides a laser beam 172 which is split by beam splitter 174 into a reference beam 178 and a carrier beam 179. The reference beam 178 is directed to the holographic storage media 119. The carrier beam 109 is directed to a reflective spatial light modulator (RSLM) 175 and is modulated thereby to provide a signal beam 180.

A reflective spatial light modulator (RSLM) 175 may comprise an assembly of a plurality of micro mirrors. Alternatively, the RSLM comprises a liquid crystal on silicon (“LCOS”) display device in which the crystals are coated over the surface of a silicon chip. The electronic circuits that drive the formation of the image are etched into the chip, which is coated with a reflective (for example, aluminized) surface.

In a manner similar to the TSLM drive 100 of FIGS. 1 and 2, the holographic storage drive 301 of FIG. 6 is operated by a control 150, comprising one or more computer processors 152 and one or more memories or storage apparatus 153. The control 150 and the holographic storage drive may form a holographic storage system 300, or the control may comprise or be supplemented by additional computer processors which together operate the drive to provide the storage functionality of the holographic storage system. For example, the control 150 operates the light source 171, the RSLM 175, the detector 130, and the positioning of the beams and/or the holographic storage media 119.

The read and read-back process is also similar to the TSLM drive 100 of FIGS. 1 and 2, creating the same images to be cross-correlated in accordance with the present invention.

Reference is made to the incorporated Ser. No. 11/737,670 Application for its showing of holographic data storage systems and matched filters.

The present invention is therefore applicable to the various holographic drives and light paths.

In summary, in one embodiment, the holographic storage drive is configured to read back the written hologram by illuminating the written hologram with an object wave; and the control is configured to operate the holographic storage drive to provide the ideal version of the known image as the object wave and to cross-correlate the resultant wave image employing a partial matched filter matched to the impulse response of a reference wave for the known image. In another embodiment, the holographic storage drive is configured to read back the written hologram by illuminating the written hologram with a reference wave; and the control is configured to cross-correlate the resultant wave image employing a partial matched filter matched to the impulse response of an ideal version of the known image.

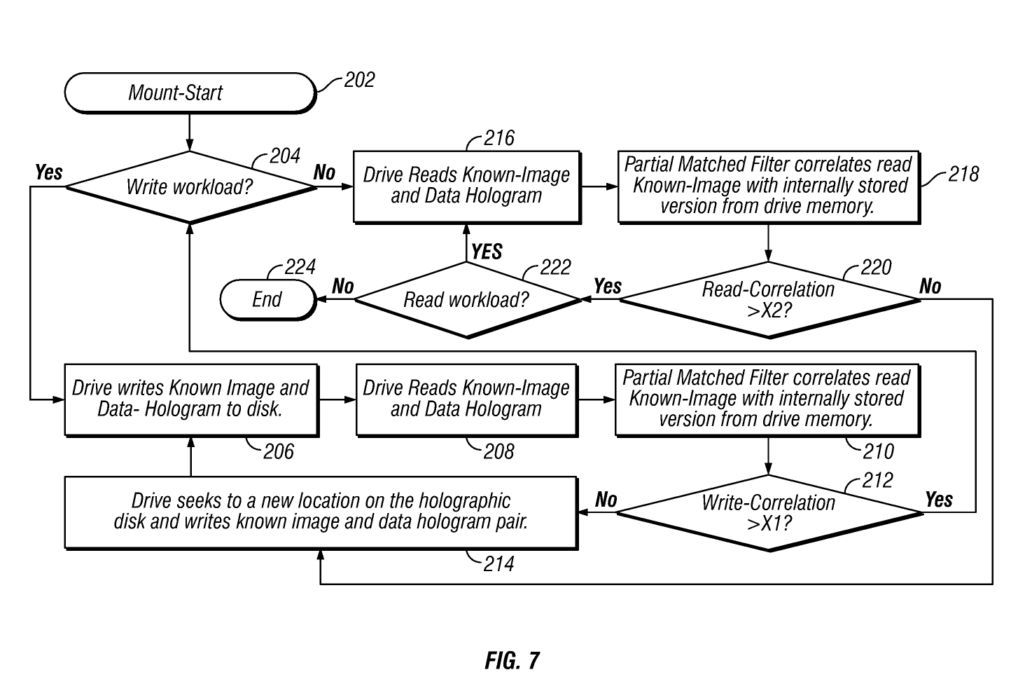

Referring additionally to FIG. 7, embodiments of the methods and computer program product implementations of the present invention begins at step 202 when the media 119 is mounted (if it is removable) on the holographic storage drive, and/or when the media is accessed. In one embodiment, after a hologram has been written, the known image is read back and cross-correlated as discussed above, and, if the control determines the cross-correlation fails to meet a write/readback threshold, the control is configured to operate the holographic storage drive to write the aggregated known image and the data in the form of a hologram at another location of the at least one holographic storage medium. In another embodiment, the control is additionally configured to operate the holographic storage drive to read a hologram having the aggregated known image and data from the holographic storage medium, employing a partial matched filter to cross-correlate the read image with the ideal version of the known image, excluding the remainder of the read hologram; and to determine whether the cross-correlation at least meets a read threshold. In a further embodiment, the read threshold is less stringent than the write/readback threshold.

In step 204, the determination is made by control 150 whether the next item of the workload is to write data to the holographic media. If so, the process flows to step 206, where the known image 120 and data 122 are written as an aggregated pair to the holographic media 119. In step 208, the control operates the holographic storage drive to read back the newly written hologram, using, in step 210, the partial matched filter to cross-correlate the read-back image with the ideal version of the known image, excluding the remainder of the written hologram, as discussed above.

In step 212, the average of V(x,y) is compared to a first write/readback correlation threshold X1. In effect, the level of imperfections is compared to threshold at which the level of imperfections is deemed to indicate a healthy hologram. If the average exceeds X1, the write is considered successful and the data storage hologram is verified, and the process flows back to step 204. Otherwise, the control determines that the cross-correlation fails to meet the write/readback threshold, and the process flows to step 214, where the control operates the holographic storage drive to write the aggregated known image and the data in the form of a hologram at another location of the at least one holographic storage medium, for example, as hologram 160.

If in step 204, there is no write workload, the process flows to step 216 for either the next read operation or a verification read of another hologram even if there is no read operation. In step 216, the control operates the holographic storage drive to read back the newly written hologram, using, in step 218, the partial matched filter to cross-correlate the read-back image with the ideal version of the known image, excluding the remainder of the written hologram, as discussed above.

In step 220, the average of V(x,y) is compared to a second read correlation threshold X2. In effect, the level of imperfections is compared to threshold at which the level of imperfections is deemed to indicate the hologram is still healthy, but the read threshold X2 is less stringent than the write/readback threshold X1. If the average exceeds X2, the read data is considered satisfactory and the process flows to step 222 to check for additional read workload or to conduct another check of a hologram. If there is none, the process ends at step 224. Otherwise, the control determines that the cross-correlation fails to meet the read threshold, and the process flows to step 214, where the control operates the holographic storage drive to relocate the aggregated known image and the data in the form of a hologram at another location of the at least one holographic storage medium, for example, as hologram 161.

Although the “average” values of V(x,y) are discussed above when comparing to the correlation thresholds X1 and X2, the worst-case value of V(x,y), the arithmetic mean of Difference (x,y), the geometric mean of Difference (x,y), or the root-mean-square of Difference (x,y) may alternatively be used.

Those of skill in the art will understand that changes may be made with respect to the methods discussed above, including changes to the ordering of the steps. Further, those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. A holographic data storage system comprising:
a holographic storage drive configured to write and read holograms with respect to at least one holographic storage medium, said holograms at a plurality of locations of a holographic storage medium; and
a control configured to operate said holographic storage drive to write a known image aggregated with data in the form of a hologram to said holographic storage medium; to operate said holographic storage drive to read back said written hologram, employing a partial matched filter to cross-correlate the read-back image with said ideal version of said known image, excluding the remainder of said written hologram; and to determine whether said cross-correlation at least meets a write/readback threshold.

2. The holographic data storage system of claim 1, wherein said control is configured to, if said control determines said cross-correlation fails to meet said write/readback threshold, operate said holographic storage drive to write said aggregated known image and said data in the form of a hologram at another location of said at least one holographic storage medium.

3. The holographic data storage system of claim 2, wherein said control is additionally configured to operate said holographic storage drive to read a hologram having said aggregated known image and data from said holographic storage medium, employing a partial matched filter to cross-correlate the read image with said ideal version of said known image, excluding the remainder of said read hologram; and to determine whether said cross-correlation at least meets a read threshold.

4. The holographic data storage system of claim 3, wherein said read threshold is less stringent than said write/readback threshold.

5. The holographic data storage system of claim 3, wherein said control is configured to, if said control determines said cross-correlation fails to meet said read threshold, operate said holographic storage drive to write said aggregated known image and said read data in the form of a hologram at another location of said at least one holographic storage medium.

6. The holographic data storage system of claim 1, wherein said holographic storage drive is configured to read back said written hologram by illuminating said written hologram with an object wave; and said control is configured to operate said holographic storage drive to provide said ideal version of said known image as said object wave and to cross-correlate the resultant wave image employing a partial matched filter matched to the impulse response of a reference wave for said known image.

7. The holographic data storage system of claim 1, wherein said holographic storage drive is configured to read back said written hologram by illuminating said written hologram with a reference wave; and said control is configured to cross-correlate the resultant wave image employing a partial matched filter matched to the impulse response of an ideal version of said known image.

8. The holographic data storage system of claim 3, wherein said holographic storage drive is configured to read back said read hologram by illuminating said read hologram with an object wave; and said control is configured to operate said holographic storage drive to provide said ideal version of said known image as said object wave and to cross-correlate the resultant wave image employing a partial matched filter matched to the impulse response of a reference wave for said known image.

9. The holographic data storage system of claim 3, wherein said holographic storage drive is configured to read back said read hologram by illuminating said read hologram with a reference wave; and said control is configured to cross-correlate the resultant wave image employing a partial matched filter matched to the impulse response of an ideal version of said known image.

10. A method for storing holograms with respect to at least one holographic storage medium, said holograms at a plurality of locations of a holographic storage medium; comprising the steps of:
writing a known image aggregated with data in the form of a hologram to said holographic storage medium;
reading back said written hologram, employing a partial matched filter to cross-correlate the read-back image with said ideal version of said known image, excluding the remainder of said written hologram; and
determining whether said cross-correlation at least meets a write/readback threshold.

11. The method of claim 10, additionally, if said determining step determines said cross-correlation fails to meet said write/readback threshold, writing said aggregated known image and said data in the form of a hologram at another location of said at least one holographic storage medium.

12. The method of claim 11, additionally,
reading a hologram having said aggregated known image and data from said holographic storage medium, employing a partial matched filter to cross-correlate the read image with said ideal version of said known image, excluding the remainder of said read hologram; and
determining whether said cross-correlation at least meets a read threshold.

13. The method of claim 12, wherein said read threshold is less stringent than said write/readback threshold.

14. The method of claim 12, additionally, if said determining step determines said cross-correlation fails to meet said read threshold, writing said aggregated known image and said read data in the form of a hologram at another location of said at least one holographic storage medium.

15. A computer program product comprising a computer usable medium embodying a computer readable program when executed on a computer causes the computer to:
operate a holographic storage drive to write a known image aggregated with data in the form of a hologram to said holographic storage medium, said holographic storage drive configured to write and read holograms with respect to at least one holographic storage medium, said holograms at a plurality of locations of a holographic storage medium;
operate said holographic storage drive to read back said written hologram, employing a partial matched filter to cross-correlate the read-back image with said ideal version of said known image, excluding the remainder of said written hologram; and
determine whether said cross-correlation at least meets a write/readback threshold.

16. The computer program product of claim 15, wherein said computer readable program when executed on a computer causes the computer to, if said determination determines said cross-correlation fails to meet said write/readback threshold, operate said holographic storage drive to write said aggregated known image and said data in the form of a hologram at another location of said at least one holographic storage medium.

17. The computer program product of claim 16, wherein said computer readable program when executed on a computer causes the computer to operate said holographic storage drive to read a hologram having said aggregated known image and data from said holographic storage medium, employing a partial matched filter to cross-correlate the read image with said ideal version of said known image, excluding the remainder of said read hologram; and to determine whether said cross-correlation at least meets a read threshold.

18. The computer program product of claim 17, wherein said read threshold is less stringent than said write/readback threshold.

19. The computer program product of claim 17, wherein said computer readable program when executed on a computer causes the computer to, if said determination determines said cross-correlation fails to meet said read threshold, operate said holographic storage drive to write said aggregated known image and said read data in the form of a hologram at another location of said at least one holographic storage medium.
